(19) United States
(12) Patent Application Publication
(10) Pub. No.: US 2012/0318200 A1
(43) Pub. Date: Dec. 20, 2012

(54) NUTRIENT DISPENSER FOR BIRDS

(75) Inventors: Thomas Van Dyk, Ramsey, NJ (US); Daehwan Kim, New York, NY (US)

(73) Assignee: Central Garden & Pet Company, Walnut Creek, CA (US)

(21) Appl. No.: 13/474,308

(22) Filed: May 17, 2012

Related U.S. Application Data
(60) Provisional application No. 61/519,164, filed on May 17, 2011.

(51) Int. Cl. A01K 39/04; A01K 39/00; A01K 39/012

(52) U.S. Cl. 119/51.5; 119/51.01; 119/52.2

(57) ABSTRACT

An apparatus is for removably receiving a container of nutrient material for dispensing the nutrient material to birds. The apparatus has a frame and a body. The body has a receptacle for removably receiving a rim of the container. The body is mounted to the frame for pivoting relative to the frame between a first configuration in which the receptacle is downwardly oriented, and a second configuration in the receptacle is upwardly oriented.

### CROSS-REFERENCE TO RELATED APPLICATION

This application claims the benefit of U.S. Provisional Patent Application No. 61/519,164, which was filed on May 17, 2011. The entire disclosure of U.S. Provisional Patent Application No. 61/519,164, which was filed on May 17, 2011, is incorporated herein by reference.

### BACKGROUND

The present invention generally relates to nutrient dispensers for birds, and more specifically relates to bird feeders with liquid dispensers.

There is widespread interest in attracting and caring for birds by making nutrients available to them. Accordingly, a wide variety of nutrient dispensers for birds (e.g., bird feeders) are well known, wherein the nutrients may be liquids, seeds or any other suitable nutrients; and there is an ongoing desire for nutrient dispensers that provide a new balance of properties such as, but not limited to, ease of use and the ability to provide a variety of different types of nutrients.

### SUMMARY

One aspect of this disclosure is the provision of an apparatus for removably receiving a container of nutrient material for dispensing the nutrient material to birds, wherein the apparatus comprises a frame and a rotary body comprising a receptacle for removably receiving at least a portion of the container, and wherein the rotary body is mounted for pivoting relative to the frame between at least a first configuration in which the receptacle is downwardly oriented, and a second configuration in the receptacle is upwardly oriented. The frame may comprise first and second nutrient dispensers that are laterally spaced apart from one another. Each of the first and second nutrient dispenser may comprise a base. The rotary body may be positioned between the base of the first nutrient dispenser and the base of the second nutrient dispenser. The rotary body may be pivotably connected to the base of each of the first and second nutrient dispensers. The rotary body may include a cavity in fluid communication with the receptacle for receiving liquid nutrient material from the container when the receptacle is in receipt of the container and the rotary body is in the second configuration, so that the cavity presents the liquid nutrient material to the birds for consumption. In contrast, each of the first and second nutrient dispensers may be for dispensing seeds so that the seeds are presented to the birds for consumption.

One aspect of this disclosure is the provision of a bird feeder with a solid nutrient dispenser portion and a liquid dispenser portion, wherein there may be relative movement (e.g., relative pivoting) between the liquid dispenser portion and the solid nutrient dispenser portion for streamlining refilling. In accordance with an exemplary embodiment of this disclosure, the solid nutrient dispenser portion includes laterally spaced apart solid nutrient dispensers. The solid nutrient dispensers may be in the form of tubular feeders that each include a base and one or more openings for providing solid nutrient to birds. The liquid dispenser portion includes an open container that may more specifically be in the form of a trough. In the exemplary embodiment, the trough is positioned between, and pivotably mounted to and pivotably supported by, the bases of the tubular feeders. The trough may be rotated relative to the tubular feeders between an uninverted (e.g, upright) configuration and an inverted configuration. For restricting relative rotation, the trough may be selectively releasably secured in the uninverted configuration with a latch or in any suitable manner. In the uninverted configuration, the trough is upwardly open so that a bird may, for example, perch on the rim of the trough and drink liquid from the trough.

In the exemplary embodiment and referring to the trough in its uninverted configuration, a container is mounted to and extends upwardly from the trough for supplying liquid to the trough. The liquid may be gravity fed from the container to the trough in response to the level of the liquid in the trough falling below a predetermined level. The container may be removable.

In one example, the container may be in the form of a bottle having a rim that is releasably mounted to a receptacle of the trough. The bottle containing liquid may initially be separate from the bird feeder, and the rim of the bottle may be closed with a cap. Any suitable liquid may be in the bottle. For example, the liquid in the bottle may be water, and the water may include additives, such as vitamins, nutrients, flavorings and/or any other suitable additives.

With the cap removed from the rim of the bottle, the bottle in an upright configuration, and the trough in its inverted configuration, the bottle may be mounted to the trough (e.g., the rim of the bottle may be inserted into the receptacle of the trough). Then, the trough may be rotated relative to the tubular feeders into the uninverted configuration. The bottle rotates with the trough so that the bottle is in its inverted configuration while the trough is in its uninverted configuration. In this arrangement, liquid drains from the bottle into the trough until the water in the trough rises to a predetermined level. That is, the gravity-fed flow of liquid from the bottle to the trough typically ceases in response to the level of the liquid in the trough reaching the predetermined level.

The foregoing presents a simplified summary of some aspects of this disclosure in order to provide a basic understanding. The foregoing is not an extensive summary and is not intended to identify key or critical elements of the invention or to delineate the scope of the invention. The purpose of the foregoing summary is to present some concepts of this disclosure in a simplified form as a prelude to the more detailed description that is presented later. For example, other aspects will become apparent from the following.

### BRIEF DESCRIPTION OF THE DRAWINGS

Having described some aspects of this disclosure in general terms, reference will now be made to the accompanying drawings, which are not necessarily drawn to scale and may be schematic. The drawings are exemplary only, and should not be construed as limiting the invention.

FIG. 1 is a front pictorial view of a bird feeder with its liquid dispenser in an upright configuration, in accordance with a first embodiment of this disclosure, wherein FIG. 1 is also illustrative of a rear pictorial view of the bird feeder of the first embodiment with its liquid dispenser in the upright configuration.

FIG. 2 is an enlarged, front pictorial view of a lower portion of the bird feeder of the first embodiment with its liquid dispenser in the upright configuration, wherein FIG. 2 is also illustrative of a rear pictorial view of the lower portion of the bird feeder of the first embodiment with its liquid dispenser in the upright configuration.

FIG. 3 is a left side pictorial view of the bird feeder of the first embodiment with its liquid dispenser in the upright configuration, wherein a right side pictorial view of the bird feeder of the first embodiment with its liquid dispenser in the upright configuration is a mirror image of FIG. 3.

FIG. 4 is a front pictorial view of the bird feeder of the first embodiment with its liquid dispenser in an inverted configuration, wherein FIG. 4 is also illustrative of a rear pictorial view of the bird feeder of the first embodiment with its liquid dispenser in the inverted configuration.

FIG. 5 is a front, top pictorial view of a bird feeder in a first configuration, in accordance with a second embodiment of this disclosure, wherein a rear, top pictorial view of the second embodiment of the bird feeder in the first configuration is a mirror image of FIG. 5.

FIG. 6 is a front, bottom pictorial view of the second embodiment of the bird feeder in the first configuration, wherein a rear, bottom pictorial view of the second embodiment of the bird feeder in the first configuration is a mirror image of FIG. 6.

FIG. 7 is a front elevation view of the second embodiment of the bird feeder in the first configuration, wherein a rear elevation view of the second embodiment of the bird feeder in the first configuration is a mirror image of FIG. 7.

FIG. 8 is a right elevation view of the second embodiment of the bird feeder in the first configuration, wherein a left elevation view of the second embodiment of the bird feeder in the first configuration is a mirror image of FIG. 8.

FIG. 9 is a top plan view of the second embodiment of the bird feeder in the first configuration.

FIG. 10 is a bottom plan view of the second embodiment of the bird feeder in the first configuration.

FIG. 11 is a front, top pictorial view of the second embodiment of the bird feeder in a second configuration, wherein a rear, top pictorial view of the second embodiment of the bird feeder in the second configuration is a mirror image of FIG. 11.

FIG. 12 is a front, bottom pictorial view of the second embodiment of the bird feeder in the second configuration, wherein a rear, bottom pictorial view of the second embodiment of the bird feeder in the second configuration is a mirror image of FIG. 12.

FIG. 13 is a front elevation view of the second embodiment of the bird feeder in the second configuration, wherein a rear elevation view of the second embodiment of the bird feeder in the second configuration is a mirror image of FIG. 13.

FIG. 14 is a right elevation view of the second embodiment of the bird feeder in the second configuration, wherein a left elevation view of the second embodiment of the bird feeder in the second configuration is a mirror image of FIG. 14.

FIG. 15 is a bottom plan view of the second embodiment of the bird feeder in the second configuration.

FIG. 16 is an isolated pictorial view of a representative one of the base bodies of the second embodiment.

FIG. 17 is a cross-sectional view of a rotary body and bottle portion taken along line 17-17 of FIG. 7.

FIG. 18 is a front, top exploded view of the second embodiment of the bird feeder without the bottle, wherein a rear, top exploded view of the second embodiment of the bird feeder without the bottle is a mirror image of FIG. 18.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention.

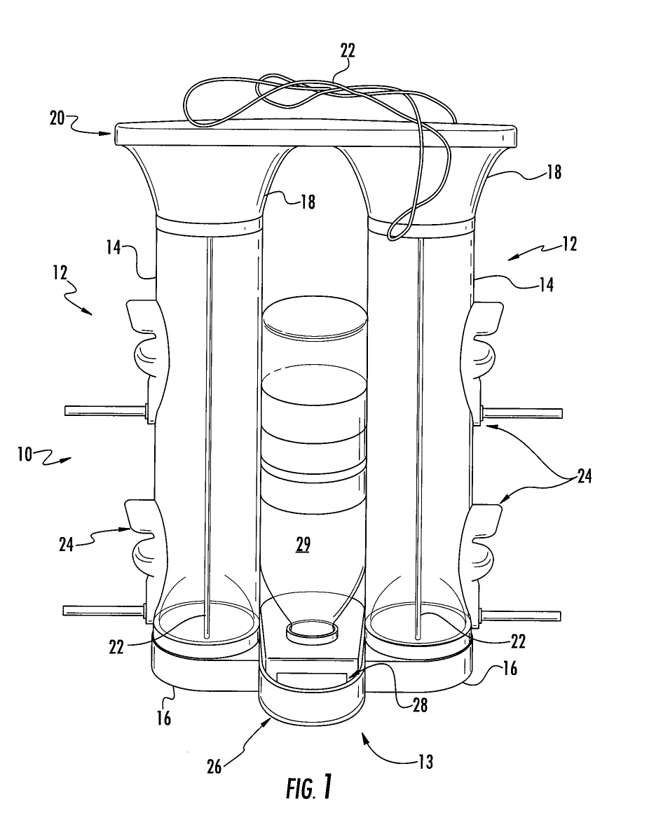

Referring now in greater detail to the drawings, FIGS. 1-4 illustrate an apparatus for dispensing a variety of nutrient material to birds, in accordance with a first embodiment of this disclosure. The apparatus of the first embodiment may be referred to as a bird feeder 10. The bird feeder 10 includes a pair of laterally spaced apart solid nutrient dispensers 12 that form a frame to which a liquid nutrient dispenser 13 is pivotably mounted. Any suitable solid nutrient material such as, but not limited to, bird seed may be dispensed by the solid nutrient dispensers 12, and the solid nutrient dispensers may be configured for dispensing different types of bird seeds or other suitable nutrients. Any suitable liquid nutrient material such as, but not limited to, water may be dispensed by the liquid nutrient dispenser 13. The water may include additives, and the liquid nutrient dispenser 13 may be configured for dispensing any other suitable nutrients. For example and alternatively, the nutrient dispenser 13 may be configured for dispensing any suitable solid nutrient material.

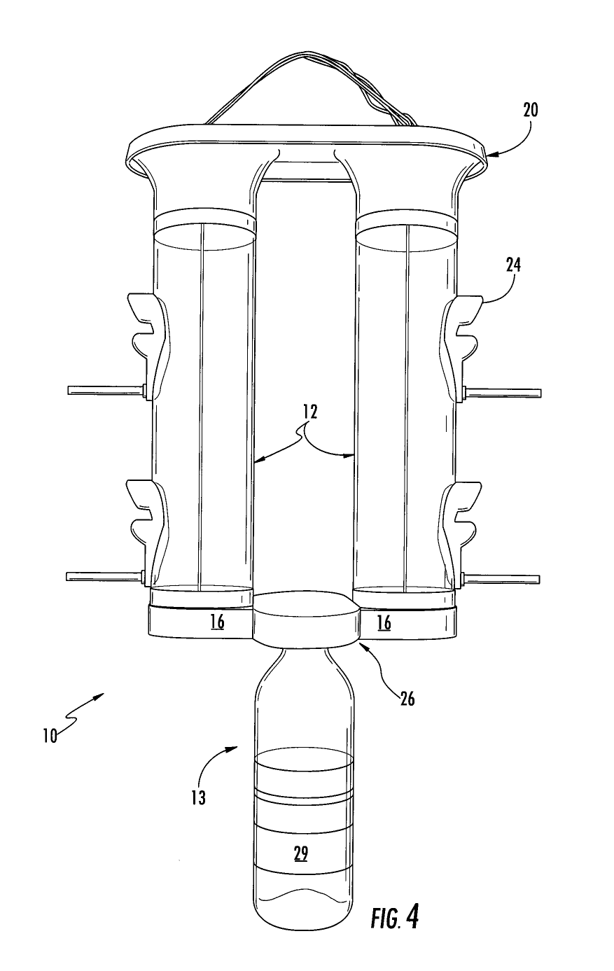

The liquid nutrient dispenser 13 is pivotably mounted to and pivotably supported by the frame or solid nutrient dispensers 12 for pivoting between the upright configuration shown in FIGS. 1-3 and the inverted configuration shown in FIG. 4. Whereas the frame of the first embodiment comprises the solid nutrient dispensers 12, any other suitable frame may be used. For example, the liquid nutrient dispenser 13 may be pivotably mounted to and pivotably supported by any suitable structure(s) such as, but not limited to, one or more differently configured bird feeders, a bird bath, post(s), mounting bracket(s) and/or the like.

Each of the solid nutrient dispensers 12 is shown in the form of a tubular feeder, although the solid nutrient dispensers may be in any other suitable forms. Each of the solid nutrient dispensers 12 includes a tube 14 extending upwardly from a base 16. For each solid nutrient dispenser 12, the base 16 is typically fixedly mounted to and closes the lower end of the tube 14. For each solid nutrient dispenser 12, solid nutrient material may be initially introduced into and replenished through an upper opening at the upper end of the tube 14. The upper ends of the tubes 14 may be closed by respective closure features 18 of a cover assembly 20, or in any other suitable manner. In the first embodiment, the bird feeder 10 may be suspended, or more specifically hung, by a length of wire, string 22 or the like having opposite ends that respectively extend through the tubes 14 and are fixedly connected to the bases 16. The string 22 extends freely through small holes in the cover assembly 20 so that the cover assembly may be moved along the string 22 to open and close the upper ends of the tubes 14. Alternatively, the bird feeder 10 may be suspended, hung or otherwise mounted in any suitable manner.

Side openings in the tubes 14 allow birds to access solid nutrient material within the tubes. Each of optional upper side openings of the tubes 14 may optionally be fitted with a conventional port assembly 24 that reinforces the side opening while still allowing sufficient passage through the side opening for feeding birds. The upper side openings and port assemblies 24 are cooperative for presenting the solid nutrient material within the tubes 14 to the birds for consumption. When the tubes 14 are made of polymeric (e.g., plastic) material that may be chewed by squirrels, the port assemblies 24 may be made of metal or other durable material for protecting the side openings, such as by discouraging squirrels from trying to enlarge the side openings by chewing the tubes. As shown in the drawings, each port assembly 24 includes a projecting perch post and other features that will be understood by those of ordinary skill in the art. Alternatively or additionally and as will be discussed in greater detail below, for each solid nutrient dispenser 12, the solid nutrient material may be dispensed under the force of gravity from one or more lower discharge ports into one or more upwardly open cavity portions of the base 16, wherein the upwardly open cavity portions of the base are for receiving, containing and presenting the solid nutrient material to the birds for consumption. Any suitable conventional port assemblies and/or discharge ports may be used. The solid nutrient dispensers 12 may be any suitable types of solid nutrient dispensers.

The liquid nutrient dispenser 13 of the bird feeder 10 includes a rotary body 26 positioned between, and pivotably mounted to and pivotably supported by, the bases 16 of the solid nutrient dispensers 12. The rotary body 26 may be pivotably mounted to and pivotably supported by the bases 16 in any suitable manner. For example, at each side of the rotary body 26, a pivot shaft may extend laterally from the rotary body into the adjacent base 16. The rotary body 26 may be rotated relative to the solid nutrient dispensers 12 between its uninverted configuration (FIGS. 1-3) and inverted configuration (FIG. 4). For selectively restricting relative rotation, the rotary body 26 may be selectively releasably secured in at least the uninverted configuration with one or more latches or in any other suitable manner, as will be discussed in greater detail below.

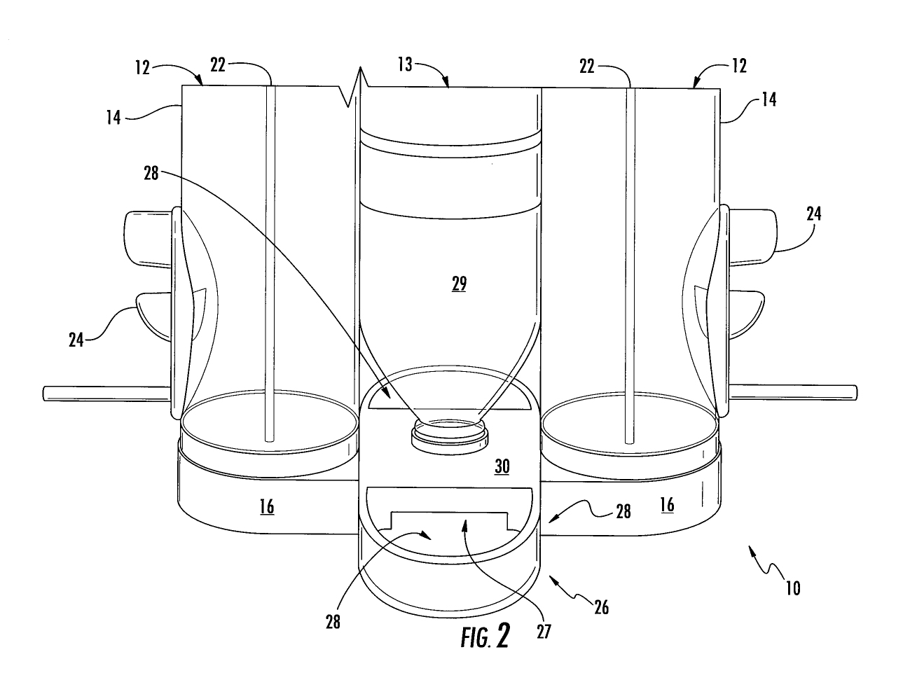

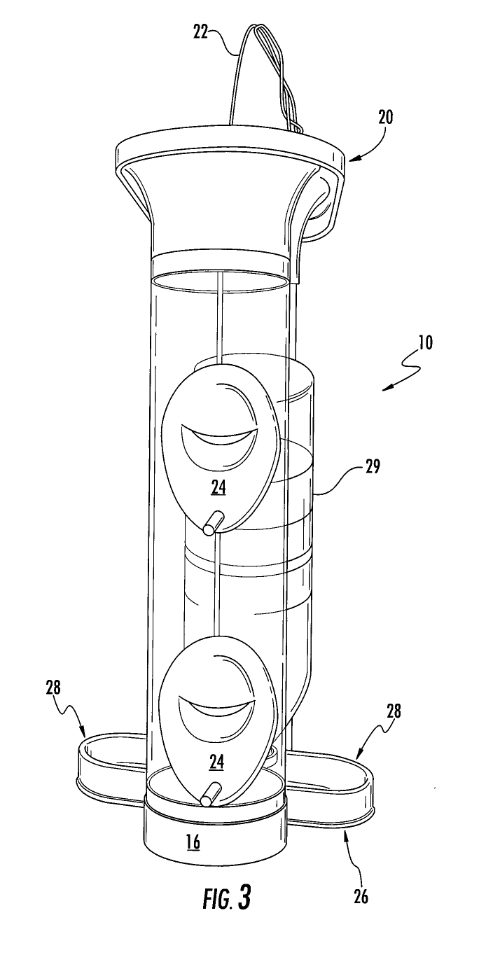

The rotary body 26 defines or otherwise comprises an elongate cavity, such that the rotary body may be in the form of a trough, or the like. As best understood with reference to FIGS. 2 and 3, and referring to the rotary body 26 in its uninverted configuration, the elongate cavity of the rotary body includes upwardly open cavity portions 28 generally at opposite ends of the rotary body, and a central cavity portion 27 positioned between and in fluid communication with the open cavity portions. The rotary body 26 includes a receptacle, which may more specifically be in the form of a receptacle plate 30 (FIG. 2). The receptacle plate 30 spans between opposite sides of the rotary body 26 such that the central cavity portion 27 is beneath the receptacle plate when the rotary body is in its uninverted configuration. The opposite open cavity portions 28 are in fluid communication with one another by way of the central cavity portion 27 that extends beneath the receptacle plate 30. The receptacle plate 30 is downwardly oriented in the inverted configuration of the rotary body 26, and the receptacle plate is upwardly oriented in the uninverted configuration of the rotary body.

The receptacle plate 30 includes a central receptacle opening that extends through the receptacle plate 30 and is in fluid communication with the central cavity portion 27. As shown in FIGS. 1-3 and referring to the rotary body 26 in its uninverted configuration, the liquid nutrient dispenser 13 includes a container in the form of an inverted bottle 29. An end portion or annular rim of the bottle 29 is releasably mounted (such as by fastener(s)) in the central receptacle opening of the receptacle plate 30, so that an interior of the bottle is in fluid communication with the central cavity portion 27 through the opening of the bottle. More generally, the bottle 29 is mounted to and extends upwardly from the receptacle plate 30 for supplying liquid to the central cavity portion 27 and thereby to the open cavity portions 28. While the liquid nutrient dispenser 13 is maintained in the upright configuration shown in FIGS. 1-3, the liquid is automatically gravity fed from the interior of the bottle 29 to the cavity portions 27, 28 in response to the level of the liquid in the cavity portions falling below a predetermined level, without the liquid overflowing from the cavity portions. In the first embodiment, the bottle 29 and receptacle plate 30 (e.g., receptacle opening) are cooperatively configured so that the single opening of the bottle is typically positioned beneath the upper surface of the liquid in the cavity portions 27, 28 while the bottle contains liquid and the liquid nutrient dispenser 13 is in its upright configuration.

While the liquid nutrient dispenser 13 is in its upright configuration, the open cavity portions 28 are upwardly open so that one or more birds may, for example, perch on the rim of the rotary body 26 and drink liquid from the open cavity portions. Alternatively, one or more perches may be connected to and extend from the rotary body 26, such as at the opposite ends of the rotary body, for being perched on by the birds. At each of the opposite ends of the rotary body 26, one or more birds may, for example, perch on the perches and drink liquid from the open cavity portions 28. The open cavity portions 28 are for containing and presenting the liquid nutrient material to the birds for consumption.

An example of a suitable method of installing a bottle 29, which may be full of liquid or any other suitable nutrient material, to the rotary body 26 is discussed in the following. The bird feeder 10 may first be hung or suspended by its string 22 or any other suitable mechanism. The bottle 29 may initially be separate from the rotary body 26. The bottle includes a rim that forms the opening of the bottle, and the bottle has a fastener in the form of external threads on the rim. The externally threaded rim of the bottle 29 may be mated with an internally threaded cap (not shown) for closing the opening of the bottle. The central receptacle opening of the receptacle plate 30 includes a fastener in the form of internal threads for mating with the external threads of the rim of the bottle 29. With the cap unscrewed from the bottle 29, the bottle in an upright configuration (e.g., the open opening of the bottle being upwardly oriented) and the rotary body 26 in its inverted configuration (FIG. 4), the bottle may be releasably mounted to the rotary body by screwing the externally threaded rim of the bottle into the internally threaded central receptacle opening of the receptacle plate 30.

As mentioned above and in accordance with the first embodiment, the bottle 29 and receptacle plate 30 (e.g., receptacle opening) are cooperatively configured so that the single opening of the bottle is typically positioned beneath the upper surface of the liquid in the cavity portions 27, 28 while the bottle contains liquid and the liquid nutrient dispenser 13 is in its upright configuration. For example, when the upright bottle 29 is being installed to the inverted receptacle plate 30 and the predetermined fully installed configuration is reached, the collar of the bottle may engage against the receptacle plate 30, or against a projecting rim of the receptacle plate or any other suitable structure, to arrest screwing of the rim of the bottle farther into the receptacle opening and thereby provide an affirmation to the user that the bottle 29 is properly installed. Any suitable cooperative features that seek to ensure proper installation of the bottle 29 may be used, and the bottle 29 may be replaced with any other suitable container.

The releasable connection between the rim of the bottle 29 and the cap and/or the connection between the rim of the bottle and the central receptacle opening of the receptacle plate 30 may be other than threaded connections; any suitable connection may be used. For example and optionally, proprietary or other special threading or attachment features may be provided between the rim of the bottle 29 and the receptacle plate 30, so that only predetermined bottles may be mounted to the receptacle plate 30.

From the configuration shown in FIG. 4, the rotary body 26 may be rotated relative to the frame (e.g., the pair solid nutrient dispensers 12), into the uninverted configuration (FIGS. 1-3), and the bottle 29 mounted to the receptacle plate 30 rotates with the rotary body so that the bottle is in its inverted configuration while the rotary body is in its uninverted configuration. That is, the liquid nutrient dispenser 13 may be rotated (e.g., flipped over) relative to the frame (e.g., solid nutrient dispensers 12), with the rotating occurring about a pivot axis defined by rotatable connections between the nutrient dispenser 13 and the frame, and the rotatable connections typically remaining intact throughout the rotating. The above-described method may be reversed to remove the bottle 29 from the rotary body 26, or the bottle 28 may be removed and/or installed in any other suitable manner.

Reiterating from above, in the arrangement shown in FIGS. 1-3, liquid drains from the bottle 29 into the cavity portions 27, 28 of the rotary body 26 until the liquid in the cavity portions rises to the predetermined level. That is, the gravity-fed flow of liquid from the bottle 29 to the cavity portions 27, 28 of the rotary body 26 typically ceases in response to the level of the liquid in the upright cavity portions reaching the predetermined level. Any suitable liquid may be in the bottle 29. For example, the liquid in the bottle 29 may be water, and the water may include additives, such as vitamins, nutrients, flavorings, sweetener and/or any other suitable additives. Bottles 29 with the same or different contents may be interchanged/may be serially installed to and removed from the central receptacle opening of the receptacle plate 30.

The rotary body 26, receptacle 30 and other features of the bird feeder 10 may be configured differently. For example, the receptacle 30 may be arranged at an end of the rotary body 26, there may be a greater or lesser number of the open cavity portions 28 and/or the like. As additional examples, differently configured containers or bottles 29 may be used and/or the receptacle(s) 30 may be adapted to receive liquid from containers arranged in parallel.

A second embodiment of this disclosure is like the first embodiment, except for variations noted and variations that will be apparent to one of ordinary skill in the art. Due to the similarity, components of the second embodiment that are identical, similar and/or function in at least some ways similarly to corresponding components of the first embodiment have reference numbers incremented by 100.

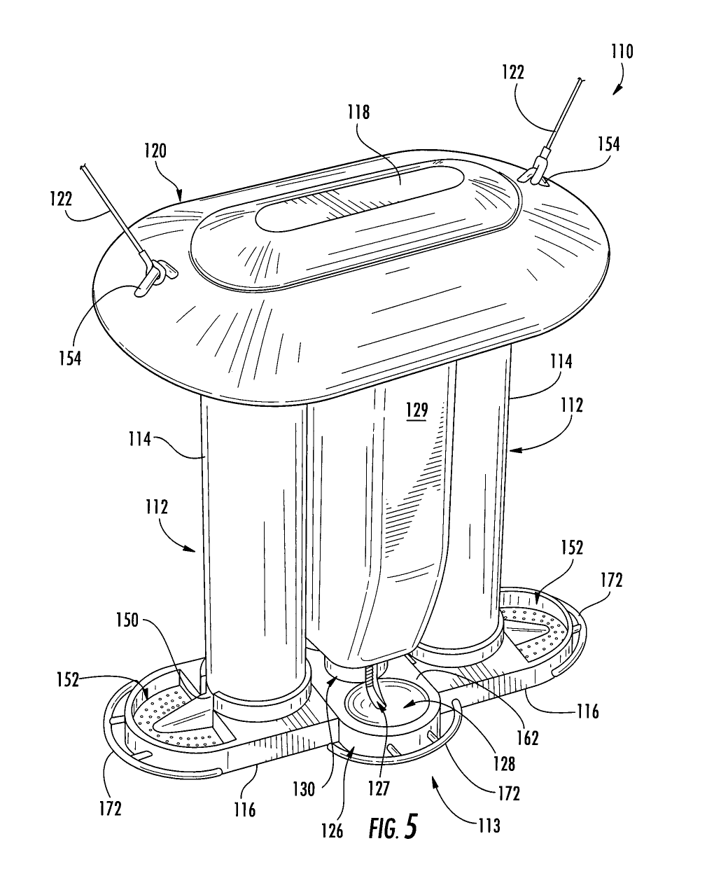

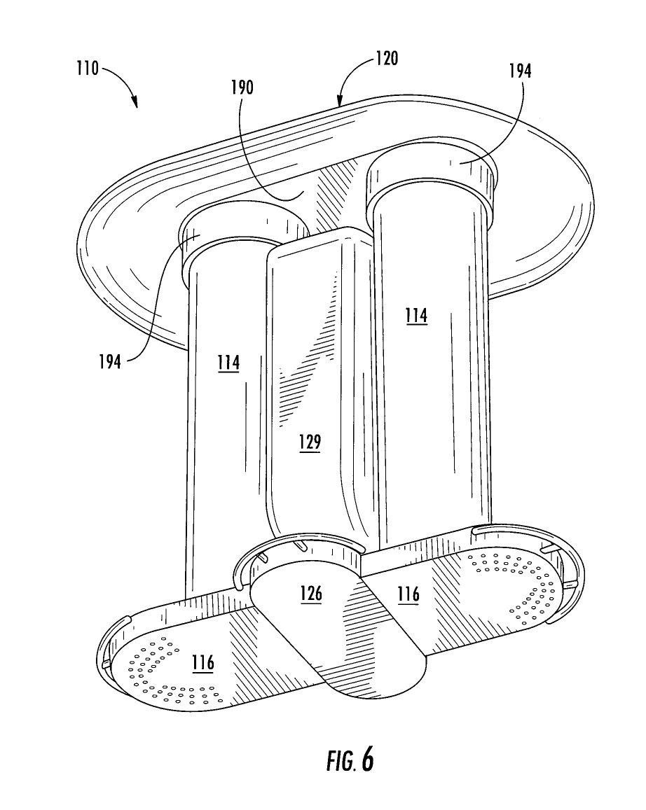

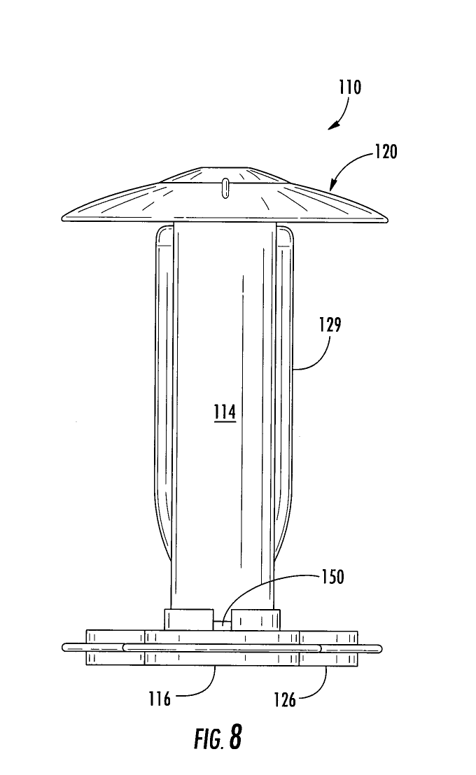

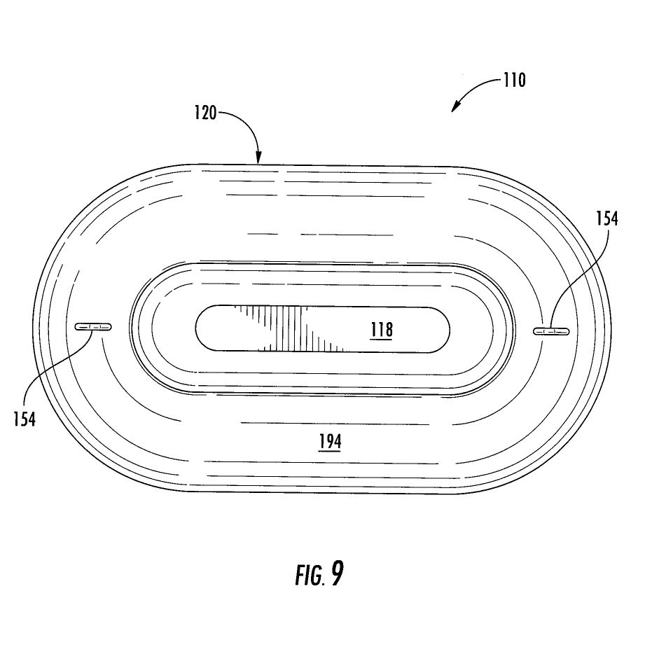

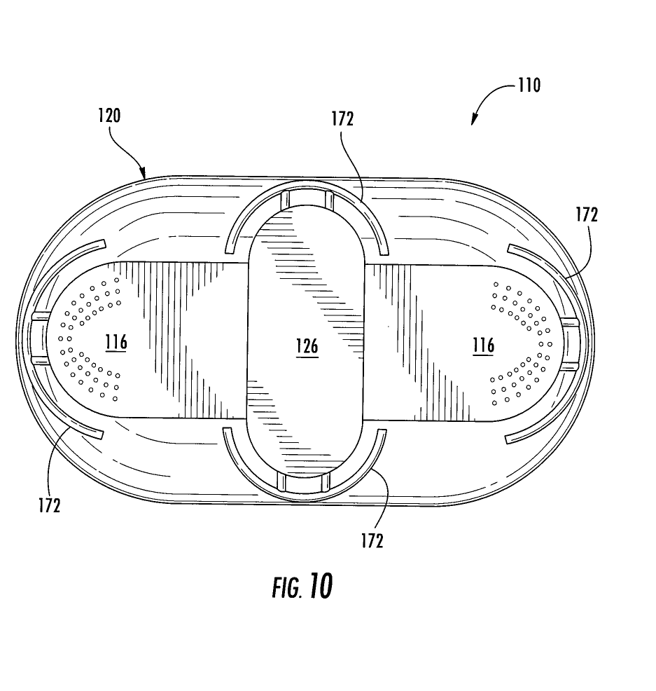

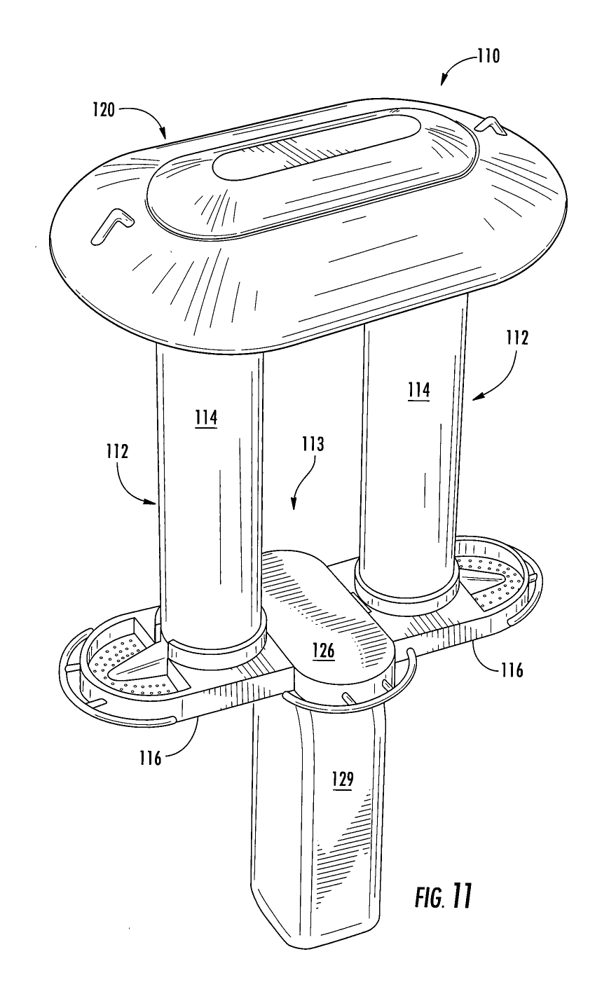

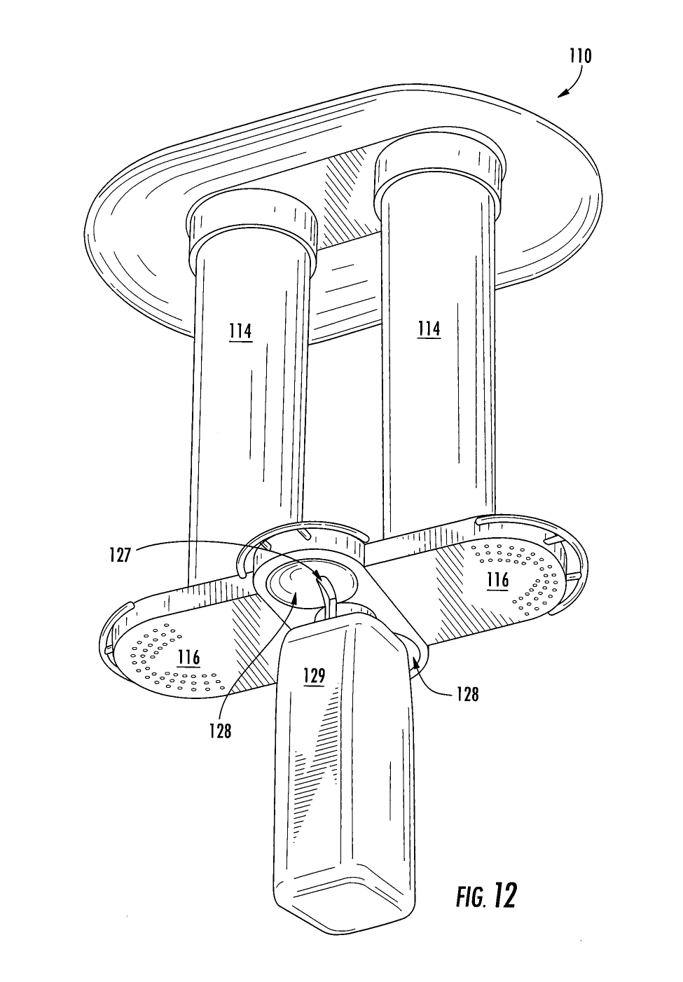

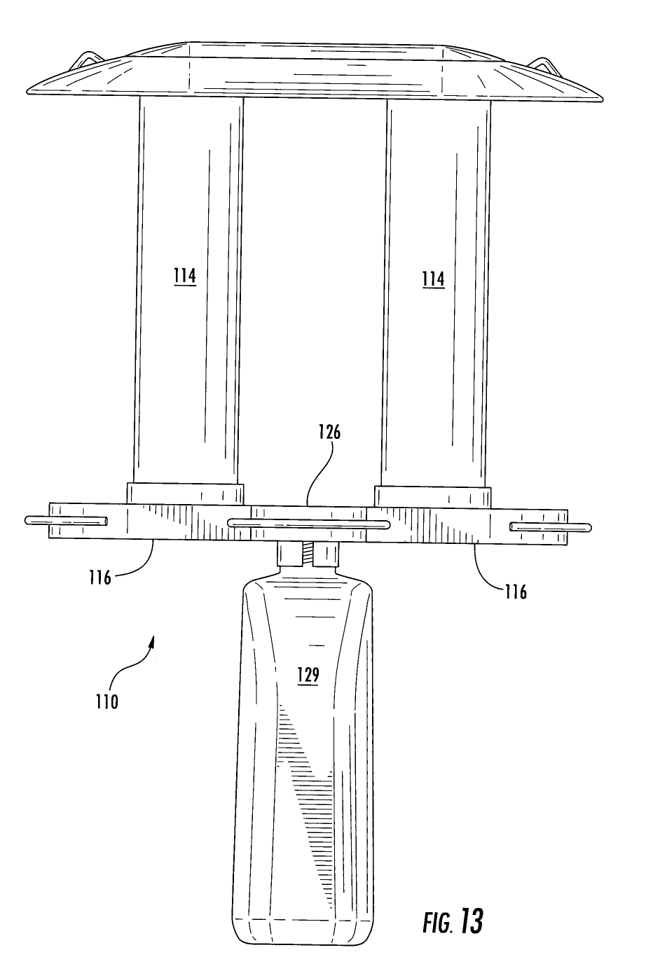

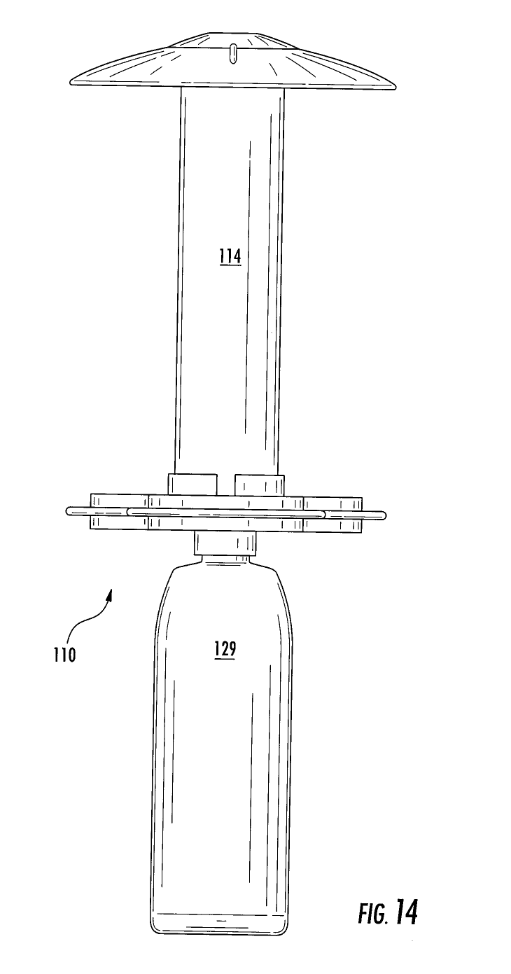

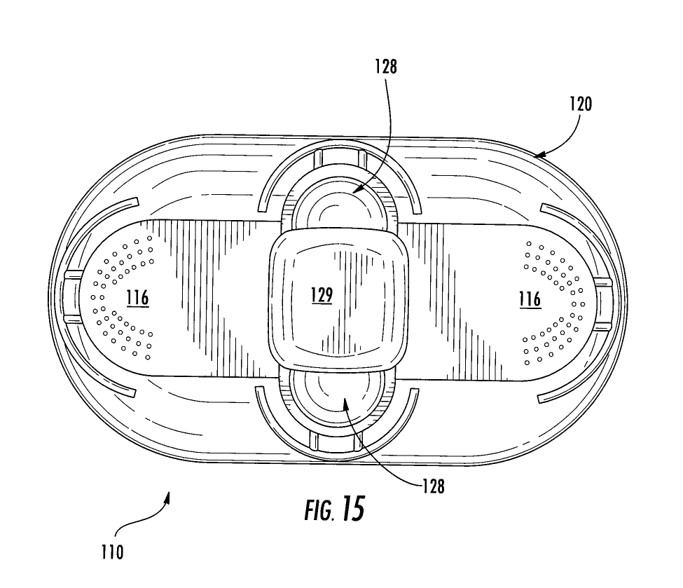

FIGS. 5-18 illustrate features of an apparatus for dispensing a variety of nutrient material to birds, in accordance with the second embodiment. The apparatus of the second embodiment may be referred to as a bird feeder 110, many features of which may be best understood with reference to FIG. 5. The bird feeder includes a pair of laterally spaced apart solid nutrient dispensers 112 that form a frame to which a liquid nutrient dispenser 113 is pivotably mounted. The liquid nutrient dispenser 113 is pivotably mounted to and pivotably supported by the frame or solid nutrient dispensers 112 for pivoting between the upright configuration shown in FIGS. 5-8 and the inverted configuration shown in FIGS. 11-15. Whereas the frame may be in the form of the solid nutrient dispensers 112, any other suitable frame may be used. For example, the liquid nutrient dispenser 13 may be pivotably mounted to and pivotably supported by any suitable structure(s) such as, but not limited to, one or more differently configured bird feeders, a bird bath, post(s), mounting bracket(s) and/or the like.

Each of the solid nutrient dispensers 112 is shown in the form of a tubular feeder, although the solid nutrient dispensers may be in any other suitable forms. Each of the solid nutrient dispensers 112 includes a tube 114 extending upwardly from a base body 116. For each solid nutrient dispenser 112, the base body 116 is typically fixedly mounted to and partially closes the lower end of the tube 114, so that solid nutrient material is automatically gravity fed from the interior of the tube through a discharge port 150 to an upwardly open cavity portion 152 of the base body. The solid nutrient material is automatically gravity fed through the discharge port 150 in response to the level of the solid nutrient material in the cavity portion 152 falling below a predetermined level, without the solid nutrient material overflowing from the cavity portions. The upwardly open cavity portions 152 are for receiving, containing and presenting the solid nutrient material to birds for consumption. Alternatively or additionally, the tubes 114 may include one or more upper side openings and/or upper side port assemblies for presenting the solid nutrient material within the tubes to the birds for consumption, such as discussed above.

For each solid nutrient dispenser 112, solid nutrient may be initially introduced into and replenished through an upper opening at the upper end of the tube 114. The upper ends of the tubes 114 may be accessed and concealed by opening and closing a lid 118 of a cover assembly 120, or in any other suitable manner. The bird feeder 110 may be suspended, or more specifically hung, by a length of wire, string 122 or the like having opposite ends that are respectively connected to eyelets 154 or other suitable fasteners that are part of, or attached to, the cover assembly 120. Alternatively, the bird feeder 110 may be suspended, hung or otherwise mounted in any suitable manner.

The liquid nutrient dispenser 113 of the bird feeder 110 includes a rotary body 126 positioned between, and pivotably mounted to and pivotably supported by, the base bodies 116 of the solid nutrient dispensers 112. The rotary body 126 may be pivotably mounted to and pivotably supported by the base bodies 116 so that the rotary body 126 may be rotated relative to the solid nutrient dispensers 112 between uninverted and inverted configurations. For selectively restricting relative rotation, the rotary body 126 may be selectively releasably secured in at least the uninverted configuration with one or more latches or in any other suitable manner, as discussed in greater detail below.

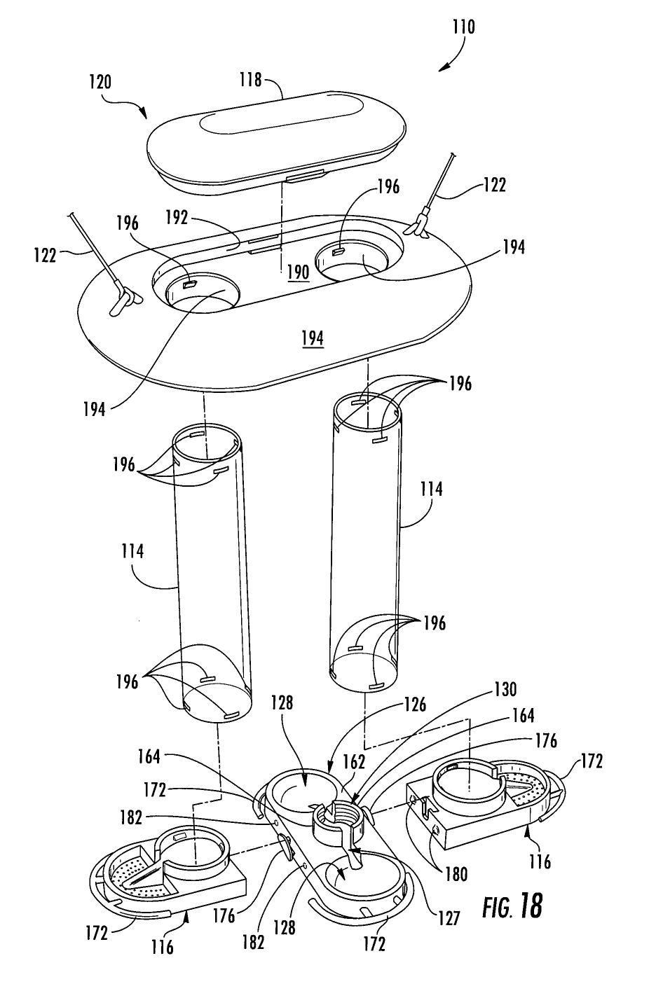

Referring also to FIG. 18, the rotary body 126 defines or otherwise comprises an elongate cavity, such that the rotary body may be at least partially in the form of a trough, or the like. Referring to the rotary body 126 in its uninverted configuration, the elongate cavity of the rotary body includes upwardly open, outer cavity portions 128 generally at opposite ends of the rotary body, and an upwardly open central cavity portion 127 positioned between and in fluid communication with the outer cavity portions.

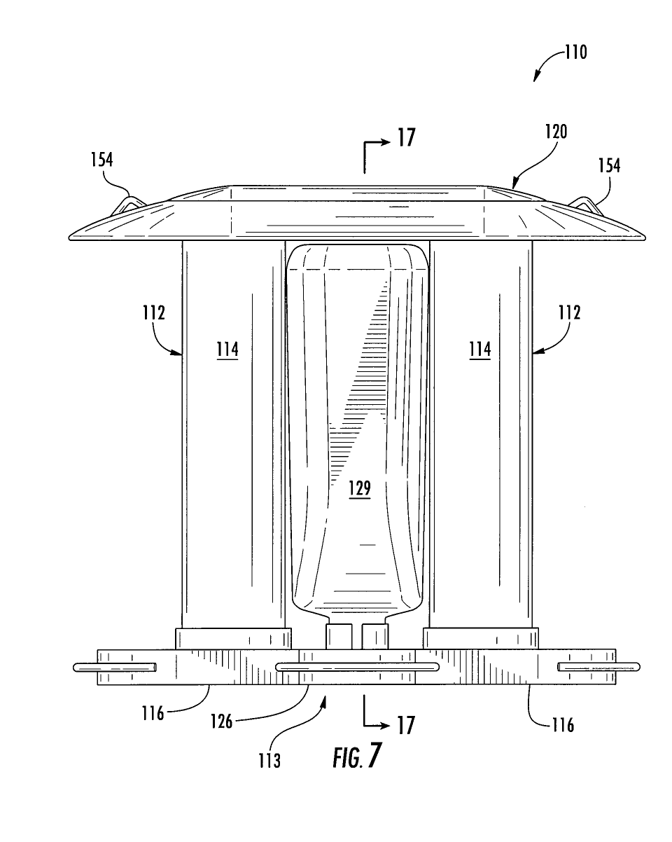

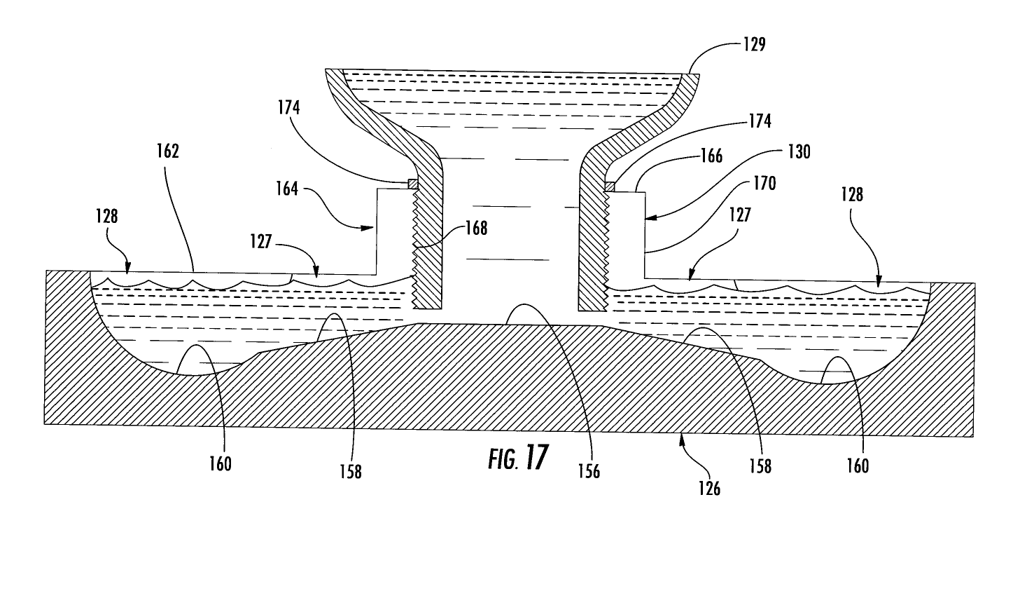

FIG. 17 is a cross-sectional view of the rotary body and a portion of the bottle 129 taken along line 17-17 of FIG. 7, and schematically showing that the bottle and the elongate cavity of the rotary body 126 contain liquid. As at least partially shown in FIG. 17, the floor of the elongate cavity of the rotary body 126 includes a central floor portion 156, sloping intermediate floor portions 158 and bowl-shaped end floor portions 160 having different depths that are below an substantially planar, outer surface 162 of the rotary body. Alternatively, the floor portions 156, 158, 160 may all have the same, or substantially same, depth as one another.

Referring to FIGS. 17 and 18, the rotary body 126 includes a receptacle 130 that defines a central receptacle opening in fluid communication with the central cavity portion 127. The cavity portions 127, 128, receptacle 130 and receptacle opening are downwardly oriented in the inverted configuration of the rotary body 126; and the cavity portions 127, 128, receptacle 130 and receptacle opening are upwardly oriented in the uninverted configuration of the rotary body.

Referring to FIGS. 17 and 18, the receptacle 130 of the second embodiment comprises a flange optionally having two slots. When the flange-like receptacle 130 has two slots, the receptacle may comprise two arcuate receptacle portions 164. Referring to the representative arcuate receptacle portion 164 shown in FIG. 17, each receptacle portion includes a arcuate shoulder surface 166, a concave inner surface 168 extending from an arcuate edge of the central floor portion 156 to an arcuate inner edge of the shoulder surface 166, and an optionally convex outer surface 170 extending from an arcuate edge of outer surface 162 to an arcuate edge of the shoulder surface 166. When the flange-like receptacle 130 has the two slots, the slots may be characterized as being gaps defined between respective opposite ends of the receptacle portions 164. A central-most portion of the central cavity portion 127 and the central receptacle opening of the receptacle 130 are defined between the concave inner surfaces 168, and the central cavity portion 127 extends through the gaps defined between respective opposite ends of the receptacle portions 164. The receptacle 130 may be configured in any suitable manner.

As best understood with reference to FIG. 17, the concave inner surfaces 168 of the receptacle 130 and the rim of the bottle 129 having mating threads so that the rim of the bottle may be screwed into and out of the receptacle opening. These threads may be replaced or supplemented with any other suitable fasteners. When the annular rim of the bottle 129 is releasably mounted in the central receptacle opening, such as by the mating threads, the interior of the bottle is in fluid communication with the central cavity portion 127 through the opening of the bottle. More generally, the bottle 129 is mounted to and extends upwardly from the receptacle 130 for supplying liquid to the central cavity portion 127 and thereby to the end cavity portions 128. In the upright configuration, the liquid in the bottle 129 is automatically gravity fed from the interior of the bottle to the cavity portions 127, 128 in response to the level of the liquid in the cavity portions falling below a predetermined level, without the liquid overflowing from the cavity portions.

In the upright configuration, the end cavity portions 128 are upwardly open so that one or more birds may, for example, perch on the rim of the rotary body 126 and drink liquid from the end cavity portions. Alternatively, one or more perches 172 may be connected to and extend from the rotary body 126, such as at the opposite ends of the rotary body, for being perched on by the birds. At each of the opposite ends of the rotary body 126, one or more birds may, for example, perch on the perches 172 and drink liquid from the end cavity portions 128. Similarly, one or more perches 172 may be connected to and extend from the base bodies 116, so that each perch of the liquid nutrient dispenser 113 is positioned between, and adjacent to, the perches of the solid nutrient dispensers 112.

An example of a suitable method of installing the bottle 129, which may be full of liquid or any other suitable nutrient material, to the rotary body 126 is discussed in the following. The bird feeder 110 may first be hung or suspended by its string 122 or any other suitable mechanism. The bottle 129 may initially be separate from the rotary body 126. The externally threaded rim of the bottle 129 may be mated with an internally threaded cap (not shown) for closing the opening of the bottle. With the cap unscrewed from the bottle 129, the bottle in an upright configuration and the rotary body 126 in its inverted configuration, the bottle may be releasably mounted to the rotary body by screwing the externally threaded rim of the bottle into the internally threaded central opening of the receptacle 130.

As mentioned above and in accordance with the second embodiment, the bottle 129 and receptacle 130 (e.g., receptacle opening) are cooperatively configured so that the single opening of the bottle is typically positioned beneath the upper surface of the liquid in the cavity portions 127, 128 while the bottle contains liquid and the liquid nutrient dispenser 113 is in its upright configuration. For example, when the upright bottle 129 is being installed to the inverted receptacle 130 and the predetermined fully installed configuration is reached, the collar 174 (FIG. 17) of the bottle may engage against the shoulder surface 166 of the receptacle 130, or any other suitable structure, to arrest screwing of the rim of the bottle farther into the receptacle opening and thereby provide an affirmation to the user that the bottle is properly installed. Any suitable cooperative features that seek to ensure proper installation of the bottle 129 may be used, and the bottle may be replaced with any other suitable container.

The releasable connection between the rim of the bottle 129 and the cap and/or the connection between the rim of the bottle and the central receptacle opening of the receptacle 130 may be other than threaded connections; any suitable connection may be used. For example and optionally, proprietary or other special threading or attachment features may be provided between the rim the bottle 129 and the receptacle 130, so that only predetermined bottles may be mounted to the receptacle.

The rotary body 126 may be rotated relative to the frame, which may be in the form of the pair solid nutrient dispensers 112, into the uninverted configuration, and the bottle 129 mounted to the receptacle 130 rotates with the rotary body so that the bottle is in its inverted configuration while the rotary body is in its uninverted configuration. The above-described method may be reversed to remove the bottle 129 from the rotary body 126.

As best understood with reference to FIG. 17, liquid drains from the bottle 129 into the cavity portions 127, 128 of the rotary body 126 until the liquid in the cavity portions rises to the predetermined level. That is, the gravity-fed flow of liquid from the bottle 129 to the cavity portions 127, 128 of the rotary body 126 typically ceases in response to the level of the liquid in the upright cavity portions reaching the predetermined level. Any suitable liquid may be in the bottle 129, and bottles with the same or different contents may be interchanged/may be serially installed to and removed from the central receptacle opening of the receptacle 130, as discussed above. As also discussed above, the rotary body 126, receptacle 130 and other features of the bird feeder 110 may be configured differently.

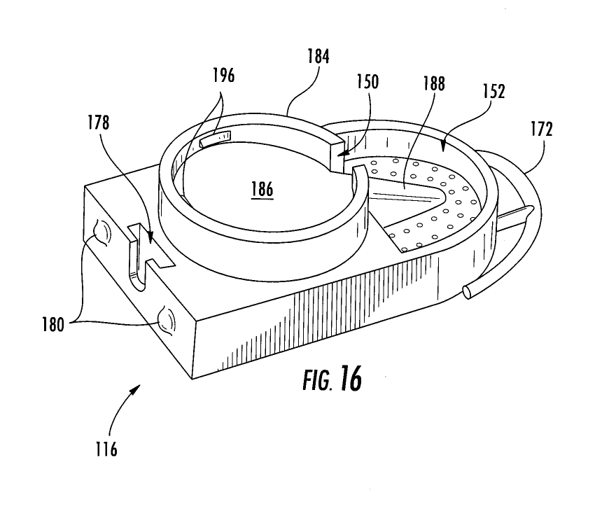

As best understood primarily with reference to FIGS. 18 and 16, the bird feeder 110 may be constructed from assembled pieces formed of any suitable materials, such as polymeric (e.g., plastic) materials. Reiterating from above, the rotary body 126 may be pivotably mounted to and pivotably supported by the base bodies 116 in any suitable manner. For example, at each side of the rotary body 126, a cylindrical pivot shaft fixedly connected to the rotary body may extend laterally outwardly from the rotary body and may terminate in the form of an annular head 176 having a larger diameter than the pivot shaft. For each pivot shaft and annular head 176, the pivot shaft may extend into, and the head may be positioned in, an upwardly open and laterally open bearing receptacle 178 (FIG. 16) in the adjacent base body 116. There may be a loose interference fit between the pivot shaft and annular head 176 and the bearing receptacle 178. The interference fits may be both loose enough to allow the rotary body 126 to rotate relative to the base bodies 116, and confining enough to restrict the annular head from exiting the bearing receptacle 178.

Alternatively, the interference fits between the pivot shafts, annular heads 176 and bearing receptacle 178 may be omitted or loose enough for allowing the pivot shafts and annular heads 176 to be easily manually lifted out of the bearing receptacles 178, so that the body 126 may be fully separated from the bases 116 for facilitating the mounting and unmounting of the bottle 129 to the body 126. In this alternative embodiment, optionally, the body 126 may not be rotatably mounted to the bases 116, such that the relative movement between the body and the bases may be translational during the mounting and dismounting of the body relative to the base bodies, with the body being rotated or flipped over while fully disconnected from the bases. In such alternative embodiments, the body 126 may be removably connected to the base bodies 116 in any suitable manner.

In accordance with the second embodiment, the rotary body 126 is selectively releasably secured for restricting relative rotation in both its inverted and uninverted configurations by latches comprising latching protrusions 180 of the base bodies 116 that are respectively received in the latching indentations 182 (FIG. 18) of the rotary body 126. The base bodies 116 and rotary body 126 may be constructed of polymeric (e.g., plastic) materials that provide a sufficient balance of rigidity and flexibility so that the latching protrusions 180 are slidable along the side faces of the rotary body 126 and project into the latching indentations 182 in a manner that selectively both allows and restricts relative rotation so that a user may readily manually rotate the rotary body between its respective configurations and the rotary body will selectively releasably remain in its inverted and uninverted configurations. The positions of the latching protrusions 180 and latching indentations 182 may be reversed, and any other suitable latching features may be used, such as, but not limited to, a protruding member or keeper mounted to one part and a hasp or clasp pivotably connected to another part and having a receptacle (e.g., opening) for releasably receiving the keeper. Any other suitable latching or attachment features may be used.

Referring to the representative base body 116 shown in FIG. 16, each of the base bodies may include an annular, slotted, lower flange 184 extending upwardly from a floor 186 that slopes toward a ramp-like diverter 188 that slopes downwardly in multiple directions into the depth of the cavity portion 152 of the base body. The discharge port 150 may be defined by the slot of the lower flange 184, a portion of the lower edge of the tube 114, the floor 186 and/or the diverter 188. Any other suitable discharge ports and/or port assemblies may be used. Holes may extend through the base bodies 116 for draining any liquid from the cavity portions 152.

As mentioned above and as best understood with reference to FIG. 18, the upper ends of the tubes 114 may be accessed and concealed by opening and closing the lid 118 of the cover assembly 120. The cover assembly 120 may include a panel 190 having holes respectively open to the upper ends of the tubes 114, a wall 192 extending upwardly from the periphery of the panel 190, and a roof or shade 194 extending outwardly from the upper edge of the wall 192. Annular upper flanges 194 extending downwardly from the panel 190 and are respectively aligned with the holes in the panel 190 and the upper ends of the tubes 114.

Pieces of the bird feeder 110 may be assembled and held together in any suitable manner, such as, but not limited to, through the use of mated fasteners 196. The fasteners 196 may include mated male and female fasteners, such as, but not limited to, barbed protrusions or tabs that are respectively received slots or other suitable openings, or the like. Any other suitable fasteners or fastening techniques may be used.

The above examples are in no way intended to limit the scope of the present invention. It will be understood by those skilled in the art that while the present disclosure has been discussed above with reference to exemplary embodiments, various additions, modifications and changes can be made thereto without departing from the spirit and scope of the invention as set forth in the claims.

What is claimed is:

1. An apparatus for removably receiving a container of nutrient material for dispensing the nutrient material to birds, the apparatus comprising:
a frame; and
a body comprising a receptacle for removably receiving at least a portion of the container, the body being mounted to the frame for pivoting relative to the frame between at least
a first configuration in which the receptacle is downwardly oriented, and
a second configuration in the receptacle is upwardly oriented.

2. The apparatus according to claim 1, wherein:
the frame comprises first and second nutrient dispensers that are laterally spaced apart from one another and each comprise a base;
the body is positioned between the base of the first nutrient dispenser and the base of the second nutrient dispenser; and
the body is pivotably connected to the base of each of the first and second nutrient dispensers.

3. The apparatus according to claim 2, wherein:
the body further comprises a cavity in fluid communication with the receptacle for
receiving liquid nutrient material from the container when the receptacle is in receipt of the container and the body is in the second configuration, and
presenting the liquid nutrient material to the birds for consumption; and
each of the first and second nutrient dispensers are for dispensing at least seeds so that the seeds are presented to the birds for consumption.

4. The apparatus according to claim 3, comprising a third nutrient dispenser, wherein:
the body is part of the third nutrient dispenser;
the third nutrient dispenser further comprises a perch extending outwardly from the body;
each of the first and second nutrient dispensers comprises a perch; and
the perch of the third nutrient dispenser is positioned between, and adjacent to each of, the perch of the first nutrient dispenser and the perch of the second nutrient dispenser while the body is in the second configuration.

5. The apparatus according to claim 1, wherein:
the apparatus comprises first and second nutrient dispensers;
the first nutrient dispenser comprises the body; and
the frame comprises the second nutrient dispenser.

6. The apparatus according to claim 1, comprising at least one latch for releasably holding the body in the second configuration.

7. The apparatus according to claim 1, wherein:
the receptacle is downwardly open in the first configuration, and
the receptacle is upwardly open in the second configuration.

8. The apparatus according to claim 1, in combination with the container, wherein:
the at least a portion of the container is a first end portion of the container;
the receptacle is in receipt of the first end portion of the container;
the first end portion of the container comprises an opening to an interior of the container;
a second portion of the container extends downwardly from the body in the first configuration;
the second portion of the container extends upwardly from the body in the second configuration for dispensing nutrient material from the interior of the container through the opening of the container to a cavity of the body; and
the cavity is upwardly open in the second configuration for receiving the nutrient material from the container and presenting the nutrient material to the birds for consumption.

9. The apparatus according to claim 1, wherein the receptacle comprises a fastener for attaching to the at least a portion of the container.

10. The apparatus according to claim 9, wherein the fastener comprises an internal thread.

11. The apparatus according to claim 1, wherein:
the body further comprises cavity in fluid communication with the receptacle for receiving nutrient material from the container when the receptacle is in receipt of the container and the body is in the second configuration,
the cavity is downwardly open in the first configuration, and
the cavity is upwardly open in the second configuration.

12. The apparatus according to claim 11, wherein:
the receptacle comprises opposite first and second arcuate portions;
each of the first and second arcuate portions comprises opposite first and second ends;
a first gap is defined between the first end of the first arcuate portion and the first end of the second arcuate portion;
a second gap is defined between the second end of the first arcuate portion and the second end of the second arcuate portion; and
the cavity comprises
a first portion extending through the first gap, and
a second portion extending through the second gap.

13. The apparatus according to claim 11, wherein:
the body includes opposite first and second ends that are spaced apart from one another in a horizontal direction both while the body is in the first configuration and while the body is in the second configuration; and
the cavity comprises
a middle portion positioned between the opposite ends of the body and in fluid communication with the receptacle for receiving nutrient material from the container when the receptacle is in receipt of the container and the body is in the second configuration,
a first end portion positioned between the middle portion of the cavity and the first end of the body, the first end portion of the cavity being for receiving nutrient material from the middle portion of the cavity when the receptacle is in receipt of the container and the body is in the second configuration, and
a second end portion positioned between the middle portion of the cavity and the second end of the body, the second end portion of the cavity being for receiving nutrient material from the middle portion of the cavity when the receptacle is in receipt of the container and the body is in the second configuration.

14. An apparatus for removably receiving a container of nutrient material for dispensing the nutrient material to birds, the apparatus comprising:
first and second nutrient dispensers that are laterally spaced apart from one another, each of the first and second nutrient dispensers being configured for dispensing nutrient material so that the nutrient material is presented to the birds for consumption; and
a body for being positioned between and connected to the first and second nutrient dispensers, the body comprising a receptacle for removably receiving at least a portion of a rim of the container, so that the container extends upwardly from the body for dispensing nutrient material from the interior of the container through an opening of the container to a cavity of the body, the cavity being upwardly open for receiving the nutrient material from the container and presenting the nutrient material to the birds for consumption.

15. The apparatus according to claim 14, in combination with the container, wherein:
the container is a bottle, and
the rim of the bottle defines the opening of the bottle.

16. The apparatus according to claim 14, wherein:
each of the first and second nutrient dispensers comprise a base;
the body is positioned between and connected both
the base of the first nutrient dispenser
the base of the second nutrient dispenser.

17. The apparatus according to claim 14, wherein the cavity of the body is in fluid communication with the receptacle for receiving liquid nutrient material from the container when the receptacle is in receipt of the at least a portion of the rim of the container and the container extends upwardly from the body.

18. The apparatus according to claim 14, comprising a third nutrient dispenser, wherein:
the body is part of the third nutrient dispenser;
the third nutrient dispenser further comprises a perch extending outwardly from the body;
each of the first and second nutrient dispensers comprises a perch; and
the perch of the third nutrient dispenser is positioned between, and adjacent to each of, the perch of the first nutrient dispenser and the perch of the second nutrient dispenser.

19. The apparatus according to claim 14, wherein:
the receptacle comprises opposite first and second arcuate portions;
each of the first and second arcuate portions comprises opposite first and second ends;
a first gap is defined between the first end of the first arcuate portion and the first end of the second arcuate portion;
a second gap is defined between the second end of the first arcuate portion and the second end of the second arcuate portion; and
the cavity comprises
a first portion extending through the first gap, and
a second portion extending through the second gap.

20. The apparatus according to claim 14, wherein:
the body includes opposite first and second ends that are spaced apart from one another; and
the cavity comprises
a middle portion positioned between the opposite ends of the body and in fluid communication with the receptacle for receiving nutrient material from the container when the receptacle is in receipt of the at least a portion of the rim of the container and the container extends upwardly from the body,
a first end portion positioned between the middle portion of the cavity and the first end of the body, the first end portion of the cavity being for receiving nutrient material from the middle portion of the cavity when the receptacle is in receipt of the at least a portion of the rim of the container and the container extends upwardly from the body, and
a second end portion positioned between the middle portion of the cavity and the second end of the body, the second end portion of the cavity being for receiving nutrient material from the middle portion of the cavity when the receptacle is in receipt of the at least a portion of the rim of the container and the container extends upwardly from the body.

21. A method of providing nutrient material to birds, comprising:
at least partially assembling a nutrient dispenser, comprising mounting a container to a body that is pivotably mounted to a frame, wherein the mounting the container to the body is performed while an open opening of the container is upwardly oriented;
then pivoting the at least partially assembled nutrient dispenser relative to the frame so that the opening of the container is downwardly oriented and gravity draws nutrient material from an interior of the container through the downwardly oriented opening of the container and the nutrient material is presented to the birds for consumption.

22. The method according to claim 21, further comprising suspending the frame prior to the mounting the container to the body, so that the frame is suspended during the mounting the container to the body.
